(19) United States
(12) Patent Application Publication
(10) Pub. No.: US 2007/0067997 A1
(43) Pub. Date: Mar. 29, 2007

(54) TRIMMER

(76) Inventor: SUSANNE BERGMAN, Kansas City, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/277,309

(22) Filed: Mar. 23, 2006

Related U.S. Application Data
(60) Provisional application No. 60/664,360, filed on Mar. 23, 2005.

(51) Int. Cl. B26B 11/00

(52) U.S. Cl. 30/123

(57) ABSTRACT

A paper trimmer and lighting system for a paper trimmer is provided.

This application claims priority pursuant to 35 U.S.C. 119(e) to co-pending U.S. Provisional Patent Application Ser. No. 60/664,360, filed Mar. 23, 2005, the entire disclosure of which is incorporated herein by reference.

### FIELD OF THE INVENTION

The present invention relates generally to tools and accessories for scrapbooking. More particularly, the present invention is concerned with an improved trimmer for use in scrapbooking and other paper cutting situation and a lighting system for paper trimmers such as the improved trimmer of the present invention.

### BACKGROUND OF THE INVENTION

I began designing a new and unique paper trimmer to fill a need I have as a crafter and teacher. I teach scrapbooking classes at our local scrapbook store and at special events. A new line of punches came out last year that require precise dimensions for mats in order for the photos or documents to fit properly in the punched slots. In addition several popular manufacturers started making odd sized scrapbooks that require precision cutting of the background papers in order for them to fit in the page protectors properly. The current trimmers on the market are ill equipped to fill these needs. They are all cumbersome, poorly marked, and are lacking the precision required for the industry's increasing demands.

I am also often asked why my layouts look better than our customers. I look at their layouts and immediately can see that it's just because their mats are crooked or uneven. When I tell them this and ask them how they measure their mats, they always reply “I just eyeball it because I can't figure out how to use my trimmer”. I have even been asked several times to teach a class specifically on “How to Use My Paper Trimmer”. Our store charges $15.00 per class. Even with this known expense they beg me to let them pay $15.00 to “learn” how to use a trimmer that cost from $25-$30. A trimmer is a simple device. It should not require a class to understand how to use it.

The instant invention successfully fills all of these requirements and more. To help you better understand the need for this necessary invention, I will narrate the situation that led me to invent a better trimmer. I teach classes to adults that wish to recreate my scrapbook sample pages which utilize EK Success' Corner Adorner Punches. Each Corner Adorner package is labeled with the precise dimensions the mat needs to be in relation to the photo in order for the punched slots to fit properly.

Scenario 1: If I want to cut a mat to fit a 4×6 picture and use the Simplicity Corner Adorner, I need to cut the mat ¼ inch larger over all. With simple dimensions like this it is very easy to make the mat. I simply cut a piece of cardstock that is 4½×6½, punch my corners and the photo will fit in the slots perfectly. It sounds very simple but the trimmers on the market are poorly suited for even this simple task.

Scenario 2: It is very common for a scrapbooker to trim the unwanted elements out of a photo before matting it. This is where the term “crop” comes from. When this occurs, you are no longer working with easy to calculate measurements. I want to mat my photo using the Simplicity Corner Adorner which requires that my mat be ¼ inch larger overall than my photo. Well, my cropped photo is now 3 11/16 by 4 3/16. Since there are no 1/16 marks on the trimmers this seems impossible but it should be very simple. Each trimmer has a cutting guide that runs parallel to the blade. Measurements on these guides would make it simple to make the required cuts but they are either absent or inadequate. The simple way to make the mat would be to adhere the photo to the mat paper and trim away the excess using the cutting guides for measurement.

### SUMMARY OF THE INVENTION

The present invention comprises a trimmer having a unique double sided blade contained in a clear plastic diamond shaped housing. The blade housing fits within a blade carriage that is permanently attached to a cutting guide. The blade housing is removable from the blade carriage for replacement with other blades, or alternatively for replacement with scoring blades or embossing nubs. The cutting guide is attached to the trimmer body by an adjustable bracket.

The trimmer lighting system of the instant invention includes a rechargeable battery power source and LED light to illuminate the surface of a trimmer. The lighting system is portable and designed to illuminate the surface of the trimmer from an edge of the trimmer. In a preferred embodiment, rods extend from the lighting system for association with tracks in a trimmer to which the lighting system is attached. In another preferred embodiment, the lighting system includes a laser pointer beam that marks the cutting line on an object before a cut is actually made.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a top view of a trimmer of the instant invention.

FIG. 2(a) is a top view of a replaceable blade housing of the instant invention.

FIG. 2(b) is a bottom perspective view of the replaceable blade housing of FIG. 2(a).

FIG. 2(c) is a side perspective view of the replaceable blade housing of FIG. 2(a).

FIG. 3 is a top enlarged fragmentary view of the trimmer of FIG. 1, showing the blade housing attached to the trimmer and located in a blade carriage, and with the blade carriage located on a cutting guide.

FIGS. 4(a), 4(b) and 4(c) shown top and side views of the blade carriage in which of FIG. 3.

FIG. 5 shows a top enlarged fragmentary view of the cutting guide and blade carriage shown in FIG. 3.

FIG. 6 shows a front view of the blade carriage of the instant invention.

FIG. 7 shows a side view of blade carriage of the instant invention located in grooves in the side of the cutting guide.

FIG. 8 shows a top enlarged fragmentary view of the cutting guide and a bracket that attaches the cutting guide to the base of the trimmer.

FIG. 9 shows a side view of the trimmer of the instant invention detailing the bracket that attaches the cutting guide to the base of the trimmer.

FIG. 10 shows a bottom view of the trimmer of FIG. 1, with the ruler at the top of the trimmer partially folded inward.

FIGS. 11 and 12 show views of a scoring blade and embossing nub, respectively, that can be used in place of the blade housing of FIG. 2.

FIG. 13 shows a trimmer lighting system of the instant invention.

FIG. 14 shows the trimmer lighting system of FIG. 13 attached to the trimmer of FIG. 1 (with the ruler at the top removed).

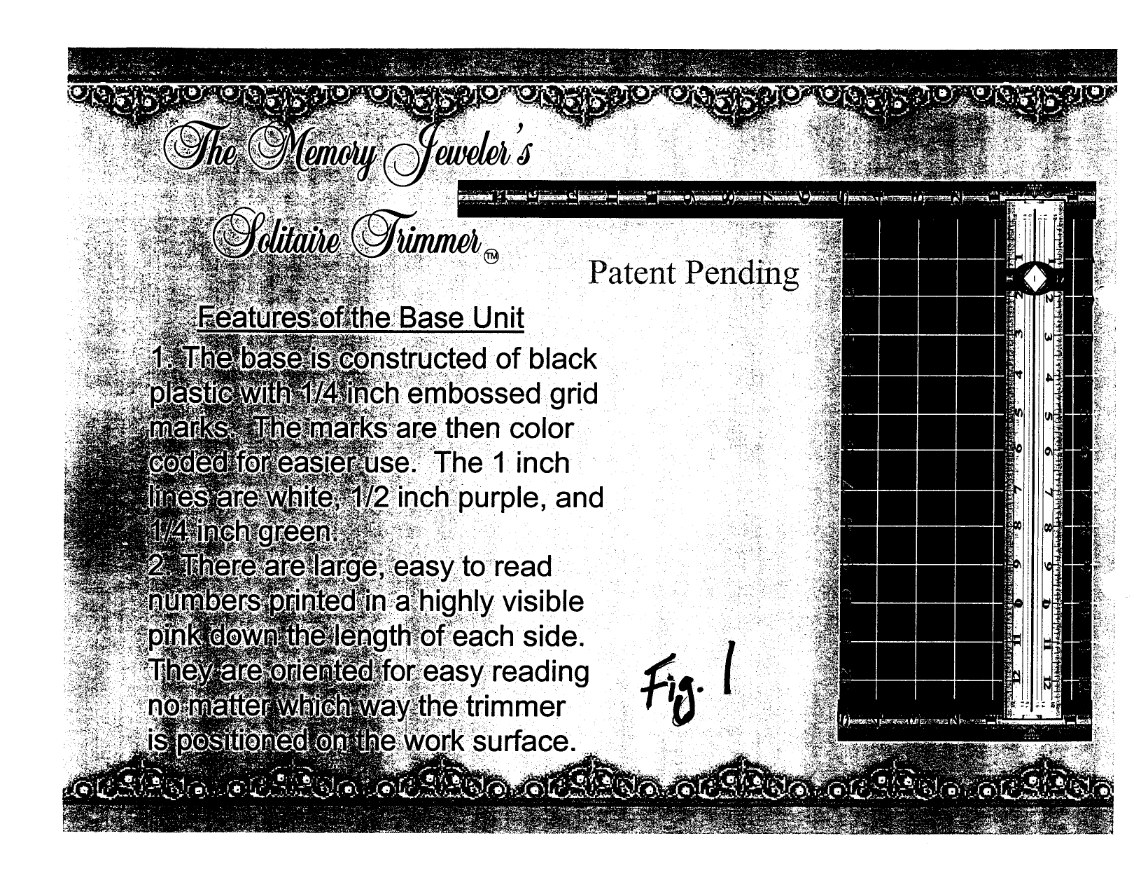

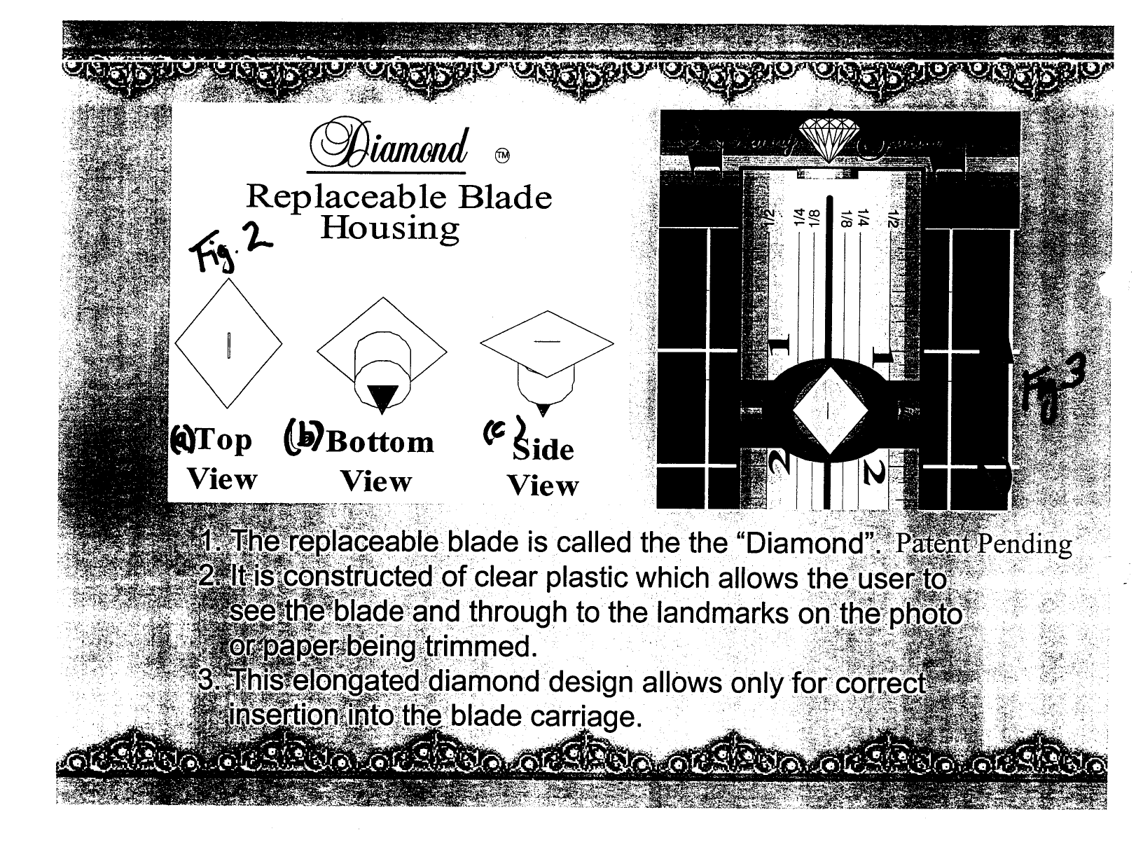

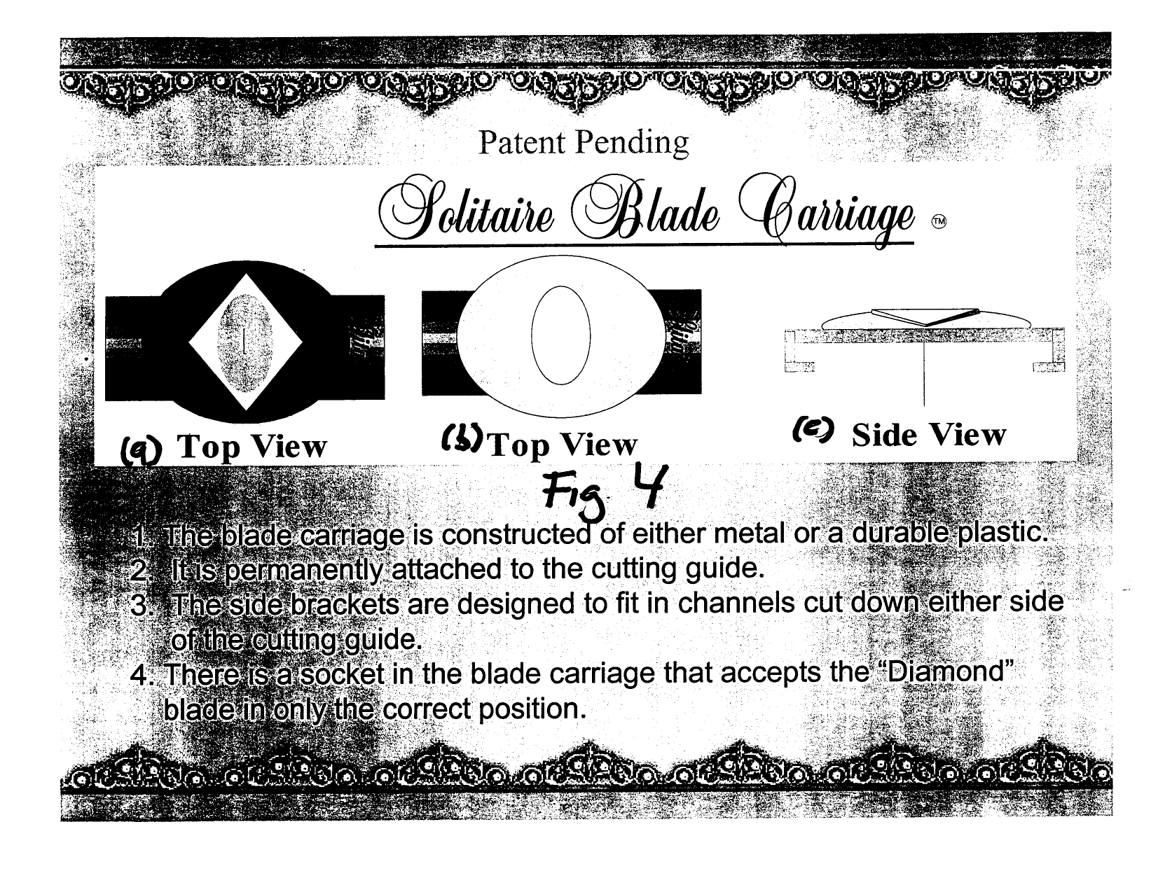

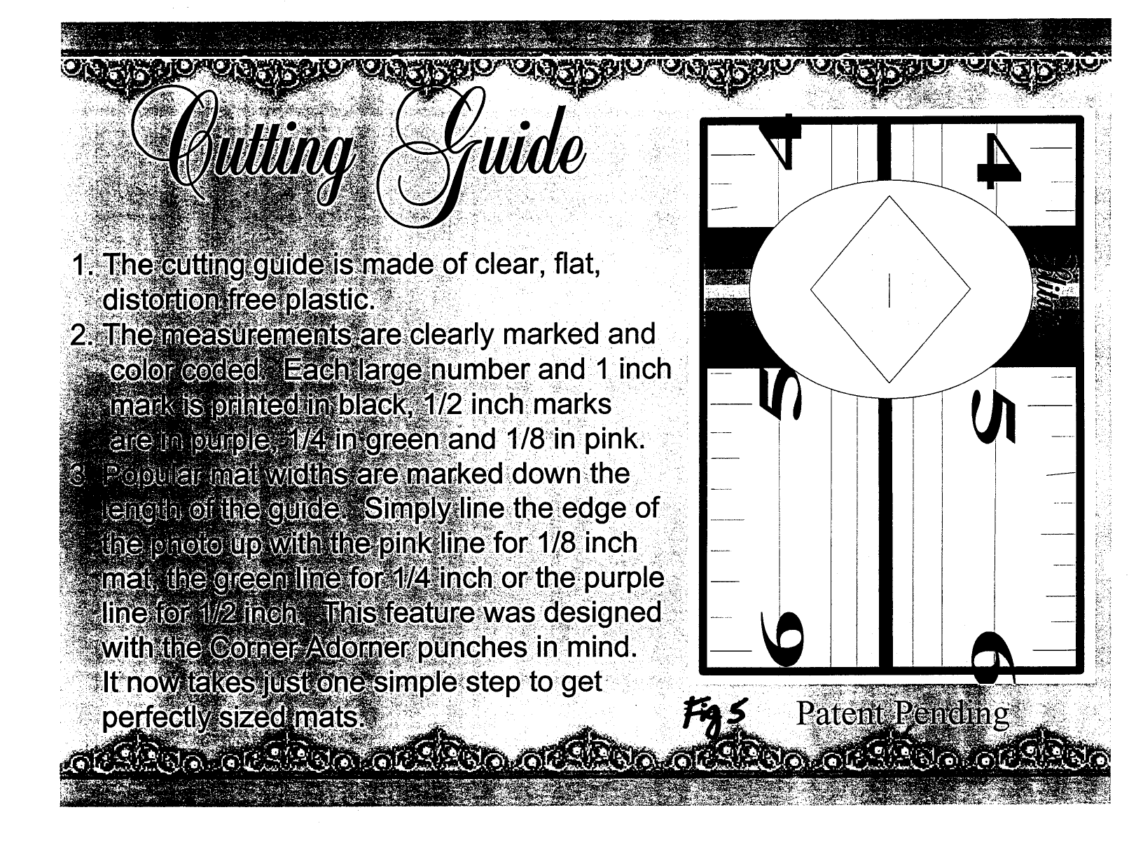

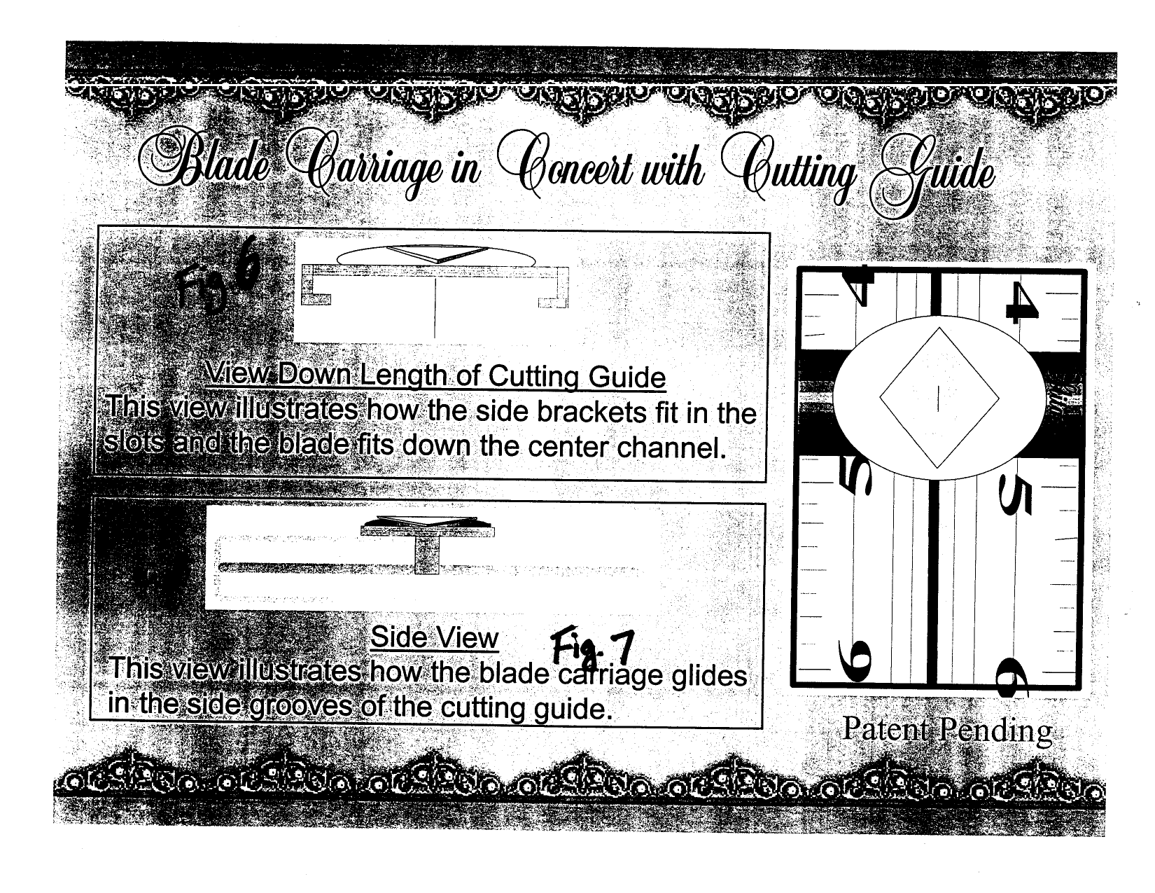

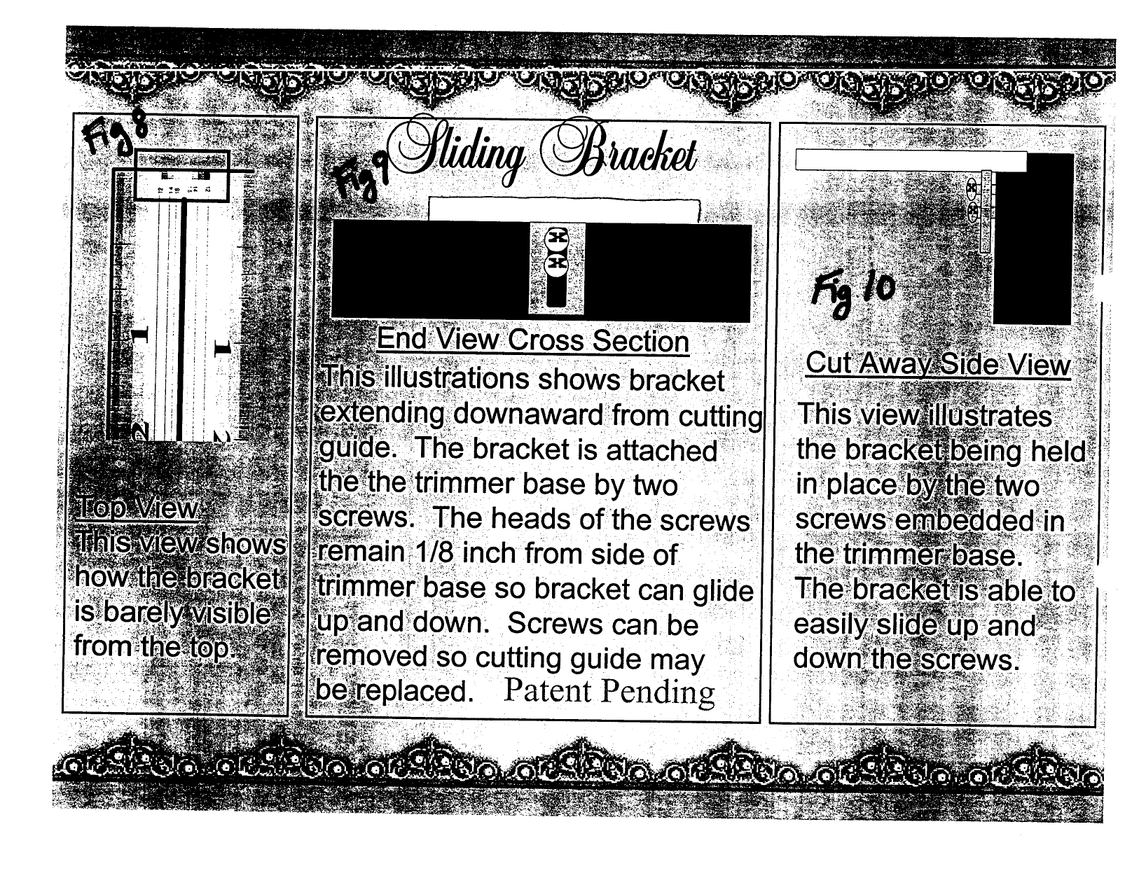

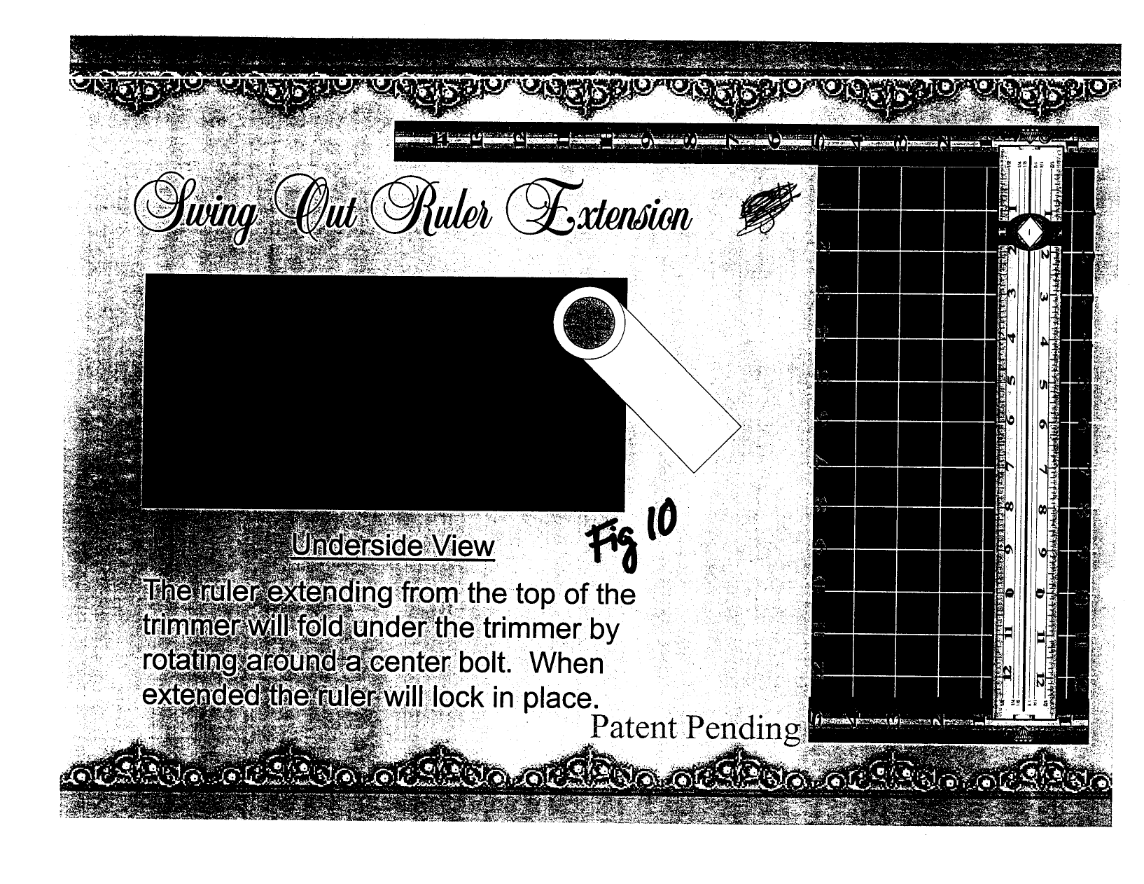

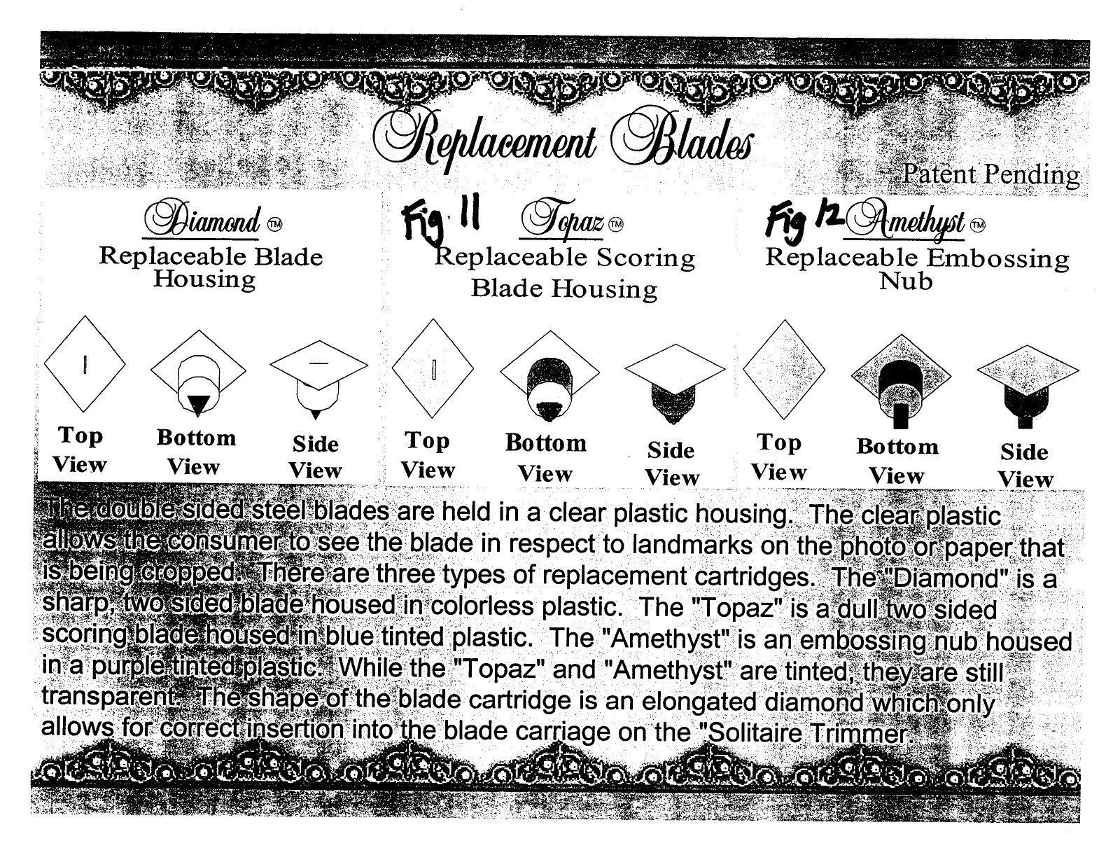

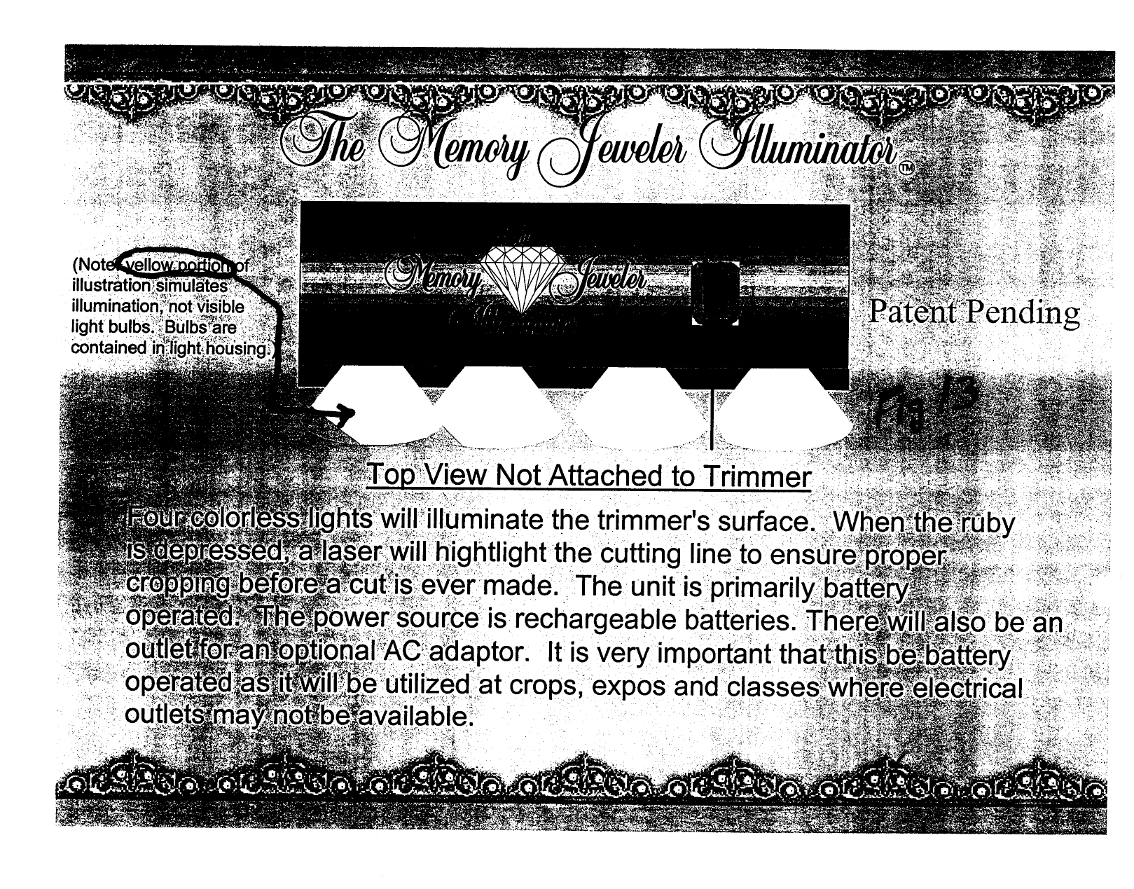

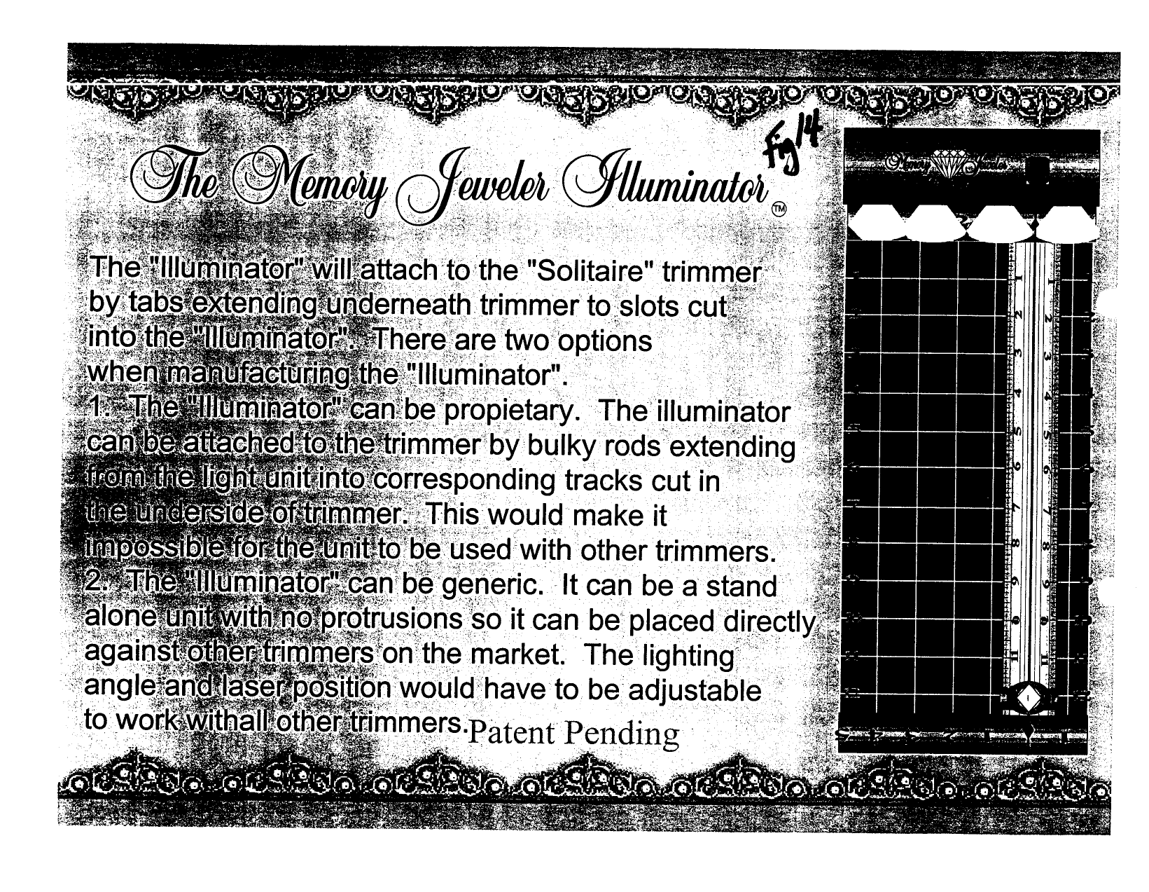

***.

### DETAILED DESCRIPTION OF A PREFERRED EMBODIMENT

As required, a detailed embodiment of the present inventions is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the Figures, a preferred embodiment of a trimmer and trimmer lighting system of the instant invention is shown and described.

In the preferred embodiment the trimmer is constructed of black plastic with multi-colored markings so it is easy to differentiate the varying measurements. There is a grid embossed on the base of the trimmer in ¼ inch increments. The grid is further enhanced by the application of white to each 1 inch line, purple to each ½ inch line and green to each ¼ inch line. The combination of embossing and colored ink application reduces the likelihood that the markings will be rubbed off during normal use. The large numbers are printed in a highly visible pink at each one inch line down both sides of the base. You will also find stainless steel rulers at each end of the trimmer. These rulers are elevated off the base of the trimmer and are at an exact 90 degree angle from the cutting line, This is very useful because you butt your piece of paper up to the ruler for accurate measurements and cutting. Each large number and 1 inch mark are printed in black, each ½ inch mark is printed in purple, each ¼ inch mark is printed in green and each ⅛ inch mark is printed in pink. The consumer is easily able to look at the ruler and be able to tell the difference between ¼ and ⅜ without having to squint to count the marks. The base of the trimmer is 5 inches wide and accommodates papers up to 12½ inches long. This length is useful as the majority of scrapbook paper sold today is 12×12. The additional ½ inch allows for the header on some papers that contains the brand name and barcode. The swing out trimmer has a one piece construction with the same colored markings that are present on the base's rulers. Cutting the 4¼×6¼ inch mat has become as simple and intuitive as it should be. I butt my paper up against the elevated ruler then line up my paper with the first green line after the 4. Since the line runs all of the way down the base, I am assured it will be a straight cut. I then turn the paper and line the edge up with the first green mark after the 6 on the swing out ruler. I can line up the bottom of the cardstock at the 4¼ inch grid mark to ensure it is straight and cut to the right dimensions with one simple glance.

The design of the trimmer of the preferred embodiment has carefully taken into consideration the need for time saving measures. The cutting guide is made of clear, flat, distortion free plastic with clearly marked measuring lines. There is a pink line running the length of the cutting guide indicating where the photo needs to be lined up to achieve an ⅛ inch mat. There is a green line for ¼ inch and a purple line for ½ inch. The outer edge of the guide lines up exactly with the 1 inch mark. There are also clearly marked ruler measurements along the outer edge of both sides of the cutting guide. The colors correspond to all of the other markings on the trimmer. Pink indicates ⅛, green indicates ¼ inch, purple indicates each ½ inch and black indicates the 1 inch interval. It is also very useful that the measurements and cutting lines run the length of each side of the cutting guide as consumers use trimmers in different positions. I always lay my trimmer so that the swing out ruler is at the top of the trimmer. My coworker always uses her trimmer so the swing out ruler is at the bottom. I have designed the cutting guide and ruler so that they are easy to read no matter how the trimmer is positioned on the work surface.

The preferred embodiment of the instant invention includes a double sided blade that is contained in a clear plastic diamond shaped housing. The diamond shape ensures correct placement in the blade carriage. The clear housing provides the ability to see exactly where the blade is in relation to any landmarks on the paper or photo being trimmed. The nature of the plastic also provides slight magnification which makes the task even easier. The final improvement is that the blade is longer than those of the prior art so it can cut through at least four pieces of cardstock at a time.

The blade carriage of the preferred trimmer of the instant invention is permanently attached to the cutting guide. The carriage has two metal braces which glide down the length of the cutting guide in channels cut in the sides each length of plastic. The carriage has a socket in the middle that accepts the blade in its clear housing. The shape of the blade housing and socket only allow for correct insertion. The design of the braces on either side of the cutting guide ensure the cutting guide and the blade itself remain straight and true even after extended use.

The cutting guide of the preferred trimmer of the instant invention is constructed of clear, flat, distortion free plastic. There are easily visible and color coded lines running down the length of the guide. On my prototype, the ⅛ inch is pink, the ¼ inch is green, the ½ is purple and the 1 inch is black. In addition, there is a ruler printed down the outer edge of each side of the guide. It is also color coded. The large numbers and one inch marks are printed in black, the ⅛ in pink, the ¼ in green and the ½ are printed in purple. The two sides of the guide are held together by ¼ inch widths of plastic located at each end. This coupled with the design of the blade carriage contribute to the trimmers stability. The cutting guide is not attached to the trimmer with hinges as in the designs of the prior art. The cutting guide is adjusted using a bracket system. There is a bracket which extends downward from the under side of each end of the cutting guide. The bracket has a channel down the center and is attached to the trimmer by two screws. The two screws provide a space between their heads and the trimmer's base which allows an easy vertical gliding motion for the cutting guide. The guide is easily lifted a fraction of an inch to allow the insertion of the paper. It is also heavy enough to hold the paper in place but light enough to allow for minor adjustments to the paper's alignment without having to physically lift the cutting guide. The ends of the cutting guide recede into notches cut into the elevated rulers found at each end of the trimmer. This also contributes to the stability and accuracy of the trimmer. The method of attachment also allows for the cutting guide to be easily replaced in the unlikely event it would become damaged.

This trimmer base of the preferred embodiment is constructed of black plastic with multicolored markings so it is easy to differentiate the varying measurements. There is a grid embossed on the base of the trimmer in ¼ inch increments. The grid is further enhanced by the application of white to each 1 inch line, purple to each ½ inch line and green to each ¼ inch line. The combination of embossing and colored ink application reduces the likelihood that the markings will be rubbed off during normal use. The large numbers are printed in a highly visible pink at each one inch line down both sides of the base. You will also find stainless steel rulers at each end of the trimmer. These rulers are elevated off the base of the trimmer and are at an exact 90 degree angle from the cutting line. This is very useful because you butt your piece of paper up to the ruler for accurate measurements and cutting. Each large numbered 1 inch mark is printed in black, each ½ inch mark is printed in purple, each ¼ inch mark is printed in green and each ⅛ inch mark is printed in pink. The consumer is easily able to look at the ruler and be able to tell the difference between ¼ and ⅜ without having to squint to count the marks. I always lay my trimmer so that the swing out ruler is at the top of the trimmer. My coworker always uses her trimmer so the swing out ruler is at the bottom. I have designed the cutting guide and ruler so that they are easy to read no matter how the trimmer is positioned on the work surface. The base of the trimmer is 5 inches wide and accommodates papers up to 12½ inches long.

As with the other measuring devises on trimmer of the preferred embodiment, the swing out ruler is color coded. The large numbers and 1 inch marks are printed in black, ½ inch in purple, ¼ inch in green and ⅛ inch in pink. The arm has a one piece construction for more durability.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

The trimmer lighting system of the preferred embodiment of the instant invention includes a rechargeable battery power source and LED light to illuminate the surface of a trimmer. The lighting system is portable and designed to illuminate the surface of the trimmer from an edge of the trimmer. In a preferred embodiment, rods extend from the lighting system for association with tracks in a trimmer to which the lighting system is attached. In another preferred embodiment, the lighting system includes a laser pointer beam that marks the cutting line on an object before a cut is actually made.

In one embodiment, the lighting system of the instant invention is designed to attach to the trimmer by tabs that extend under the trimmer and into slots cut into the trimmer. In such an embodiment, the light angle and laser guide may be preset for the trimmer in which the system is pre-designed to attach. In this embodiment, the laser guide is located in alignment with the cutting guide (such as the guide of FIG. 5) on the end opposite the starting position for the blade carriage that slides along the cutting guide. Alternatively, the lighting system base is designed to stand alone against the edge of any trimmer. In such an embodiment, the light angle and laser position may be adjustable to vary depending upon specific needs for different trimmers.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A lighting system for a paper trimmer comprising:
a light source for illuminating a trimmer base; and
unidirectional light source for illuminating a cutting location.
